(19) United States
(12) Patent Application Publication
(10) Pub. No.: US 2008/0270200 A1
(43) Pub. Date: Oct. 30, 2008

(54) SYSTEM AND METHODS FOR PANDEMIC PLANNING

(75) Inventors: Amir Khan, Brookfield, CT (US); Harald Meyer, Altdorf (DE); John Moore, Brownsburg, IN (US); Blanche M. Waddell, White Plains, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/741,927

(22) Filed: Apr. 30, 2007

(51) Int. Cl. G06Q 99/00; G06F 17/40

(52) U.S. Cl. 705/7; 703/6; 707/104.1

(57) ABSTRACT

A method for pandemic planning includes conducting a preparation stage comprising identifying and inventorying core requirements of an entity's operation; conducting a planning stage including developing action plans to implement the identified core requirements; conducting a practice stage including simulating the action plans; and conducting a performance stage including executing the plans. Each stage considers four focus areas: a people focus area, a policy focus area, a process focus area, and a politics focus area.

### I. FIELD OF THE INVENTION

The present invention relates to a system and methods for planning for a pandemic before one occurs.

### II. BACKGROUND OF THE INVENTION

Currently, there is no structured way to plan for a pandemic which takes into account the specific challenges that a global pandemic outbreak provides. Current solutions for catastrophe management are focused on point-in-time situational catastrophes. However, point-in-time catastrophes, such as earthquakes, hurricanes, tornadoes, terrorist attacks, and power grid failures, do not have the longevity or the broad-ranging geographical effects of a global pandemic, for example, an influenza pandemic such as Asian bird flu.

The U.S. Centers for Disease Control (CDC) recently issued advisory pandemic guidelines depending upon the severity of an outbreak, but the guidelines do little to help prepare for a pandemic. Instead, the guidelines are directed to interventions that limit the spread of a pandemic, such as isolation, quarantine of households, reduction of social contacts, and modification of work schedules. Accordingly, there is a need for pandemic planning model that allows entities to prepare for a pandemic and that also gauges their level of readiness. The World Health Organization (WHO) forecasts an outbreak of a pandemic in the near future.

### III. SUMMARY OF THE INVENTION

According to an aspect of the invention, a method for pandemic planning is provided. A preparation stage is conducted including identifying and inventorying core requirements of an entity's operation. A planning stage is conducted including developing action plans to implement the identified core requirements. A practice stage is conducted including simulating the action plans. Each stage considers a people focus area, a policy focus area, a process focus area, and a politics focus area.

According to another aspect of the invention, a method for pandemic planning is provided. A preparation stage is conducted including identifying and inventorying core requirements of an entity's operation. A planning stage is conducted including developing action plans to implement the identified core requirements. A practice stage is conducted including simulating the action plans. A performance stage is conducted including executing the action plans and tracking performance. Each stage considers a people focus area, a policy focus area, a process focus area, and a politics focus area.

According to another aspect of the invention, a system for pandemic planning is provided. The system includes an agent for allowing a preparation stage, a planning stage, a practice stage, and a performance stage of a pandemic planning process; and at least one database for storing at least one of communications, policies, processes, or governance models.

According to another aspect of the invention, a computer program product is provided comprising a computer useable medium having a computer readable program. The computer readable program, when executed on a computer, causes the computer to conduct a preparation stage including identifying and inventorying core requirements of an entity's operation; conduct a planning stage including developing action plans to implement the identified core requirements; conduct a practice stage including simulating the action plans; and conduct a performance stage including executing the action plans and tracking performance. Each stage considers a people focus area, a policy focus area, a process focus area, and a politics focus area.

### IV. BRIEF DESCRIPTION OF THE DRAWINGS

FIG. 1 is a flowchart illustrating a method of pandemic planning according to the present invention.

FIG. 2 is a block diagram illustrating a system for pandemic planning according to an embodiment of the present invention.

FIG. 3 is a block diagram illustrating an agent according to an embodiment of the present invention.

### V. DETAILED DESCRIPTION OF THE DRAWINGS

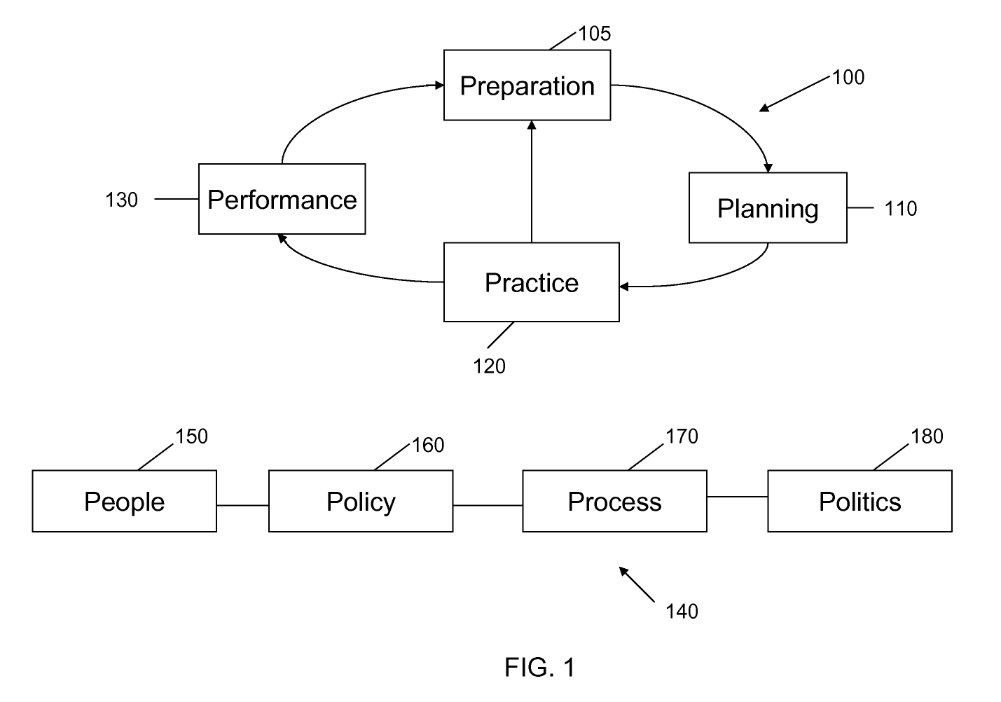

FIGS. 1-3 show a system and methods for planning for a pandemic before one occurs (pre-pandemic planning). The methods of the present invention require entities, such as businesses, governments, government agencies, communities, the military, hospitals, universities, or schools, to focus on evaluating what factors are critical to their operation in a global pandemic emergency.

In this detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

As shown in FIG. 1, a method according to the present invention comprises a continuous, closed loop 100 comprising conducting a Preparation stage 105, conducting a Planning stage 110, conducting a Practice stage 120, and conducting a Performance stage 130. Each stage may be executed in order. There may be some overlap between stages as subsequent stages build on the work of earlier stages. The closed loop process 100 allows for the continuous evaluation and improvement in the way entities prepare for a pandemic.

In each stage, consideration and analysis of four focus areas 140 ensure adequate preparedness for a pandemic. The four focus areas are People 150; Policy 160; Process 170; and Politics 180. The combination of the four stages and four focus areas comprise a methodology known as the 8 P's of pandemic planning.

The first focus area is People, 150. In embodiments, the People focus area includes, but is not limited to, actions to ensure that members (e.g., employees) of an entity understand their responsibilities in the event of a pandemic. The People focus area enables an entity to ensure that it understands the human resources needed for continuing to be active during a pandemic.

The second focus area is Policy, 160. In embodiments, the Policy focus area includes, but is not limited to, actions to establish consistent entity policies that apply to at least one of people, assets, infrastructure, services, or processes in the event of a pandemic.

The third focus area is Process, 170. In embodiments, the Process focus area includes, but is not limited to, actions to enable an entity to understand its key processes and supporting infrastructure in the event of a pandemic. The Process focus area helps an entity direct resources to ensure that these critical processes and infrastructure remain operational during a pandemic.

The fourth focus area is Politics, 180. In embodiments, the Politics focus area includes, but is not limited to, actions to determine the governance of an entity to ensure it remains viable in the event of a pandemic.

The four stages ensure that each focus area is adequately represented and considered. In the following discussion, each stage and each focus area of the method according to the present invention will be addressed. Although the discussion is directed to pandemic planning, the methods disclosed may also be applicable to other types of emergency or catastrophe planning.

### I. Preparation Stage

As shown in FIG. 1, conducting the Preparation stage 105 is the initial step in the pandemic planning process 100 of the present invention. The Preparation stage identifies and inventories core requirements of an entity's operation that may be important in the event of a pandemic. The core requirements include, but are not limited to, at least one of people, assets, infrastructure, services, or processes. The core requirements provide the fundamental building blocks for the rest of the pandemic planning process. In embodiments, the core requirements may be inventoried in at least one database.

The Preparation stage 105 takes into account the People focus area 150 by establishing at least one crisis management team to guide the pandemic planning process. In embodiments, a Crisis Management Team comprises executives at a specific site or for a specific country. A Corporate Crisis Management Team comprises senior executives of an entity, for example the CEO of a company, and guides pandemic planning for an entire entity once a pandemic reaches a specific level (e.g., WHO pandemic Level 4). A Pandemic Response Team comprises first responders including, but not limited to, building operators, first aid providers, or individuals who are to remain on site in the event of a pandemic.

The Preparation stage 105 identifies and inventories communications that must be provided to members or employees of an entity in the event of a pandemic. In embodiments, the communications are directed to at least one area of security, safety, work requirements, benefits, or payroll. In embodiments, the Preparation stage 105 identifies and inventories skills and educational level for members or employees of an entity. The identified communications, skills, and education level may be stored in a database.

The Preparation stage 105 takes into account the Policy focus area 160 by identifying and inventorying policies affecting at least one of people, assets, infrastructure, services, or processes. Existing disaster recovery policies may be modified to cover a pandemic event.

For example, the Preparation stage may identify policies for employees (e.g., human resources protocols) during a pandemic. Such policies may include, but are not limited to, at least one of (1) how employees will get paid; (2) whether a company will maintain existing payroll practices; (3) how to contain and manage benefits, for example, health benefits; or (4) establishing criteria to determine which employees are essential and may be required to remain on site. The Preparation stage 105 may establish policies for determining how at least one of key assets, services, or infrastructure may be affected during a pandemic. In embodiments, identified policies may be stored in a database, for example, a policies database.

The Preparation stage 105 takes into account the Process focus area 170 by identifying and inventorying processes that support and facilitate the management of at least one of people, assets, infrastructure, or services in the event of a pandemic. For example, key processes relating to at least one of employees, customers, clients, or government regulations are identified. In embodiments, a list of key processes may be identified and inventoried for each unit of an entity, for example, each business unit. Identified processes may be stored in a database, for example, a pandemic management database.

This part of the Preparation stage also defines when a pandemic occurs, for example, declaration of pandemic level 4 by WHO or category 4 by the CDC, and therefore when an overall pandemic plan developed according to the present invention should be implemented.

The Preparation stage 105 takes into account the Politics focus area 180 by establishing a governance model for an entity. The governance model standardizes decision-making during a pandemic. In embodiments, the governance model ensures that subunits of an entity, for example, individual business units, make decisions that are consistent with the entire entity. The political and legal implications of the governance model should be consistent with executive management who are accountable for decisions made during a pandemic. Governance models may be stored in a database.

In embodiments, the identification of core requirements may be facilitated by using at least one of (1) a Professional Development tool that assesses skills of employees of an entity and may be used, for example, to locate subject matter experts or to find individuals with skills needed for a specific commercial account; or (2) a Business Transformation Management tool for identifying at least one of key employees, customers, clients, or government regulations and requirements.

### II. Planning Stage

Conducting the Planning stage 110 is the second step in the pandemic planning process according to the present invention. The objective of the Planning stage is to develop action plans or playbooks to implement the core requirements identified in the Preparation stage 105. In embodiments, the resulting action plans may be inventoried in at least one database.

The Planning stage 110 takes into account the People focus area 150 by developing action plans to implement communication requirements identified in the Preparation stage across an entity, for example, on at least one of site, regional, country or entity-wide level. In embodiments, such communication plans may be developed by analyzing at least one of critical applications, critical skills, critical sites, key suppliers, or critical site contingency plans.

The Planning stage 110 takes into account the Policy focus area 160 by developing action plans to ensure consistent implementation of policies relating to at least one of people, assets, infrastructure, services, or processes as identified in the Preparation stage 105. In embodiments, policies may be streamlined to ensure short reaction times, for example, quick order approvals or quick delivery of goods and services. The plans may be inventoried in a database, for example, a policies database.

The Planning stage 110 takes into account the Process focus area 170 by developing action plans that implement and support key processes as identified in the Preparation stage 105. In embodiments, processes may be established to deploy necessary equipment or supplies, as well as any support. The plans may be inventoried in a database, for example, a pandemic management database.

The Planning stage 110 takes into account the Politics focus area 180 by developing action plans to implement a governance model, for example, providing roles and responsibilities for the people within the entity. In embodiments, the Planning stage 110 addresses how decisions are made and the chain of command in making such decisions. In embodiments, the plans may be inventoried in a database.

In embodiments, the development of action plans may be facilitated by using at least one of (1) team rooms, which may comprise a repository of materials including, but not limited to, at least one of meeting minutes, reference materials, status of projects, workflow items, a library of IT documents, spreadsheets, presentations, or any combination thereof; (2) databases of inventoried core requirements from the Preparation stage; (3) a Monitoring tool, for example, for tracking and monitoring usage (e.g., uptime and downtime) of at least one of key infrastructure, services, or resources; or (4) a Conferencing tool, such as phone or videoconferencing; (5) a Business Transformation Management tool for identifying at least one of key employees, customers, clients, or government regulations and requirements; (6) a Threat Assessment Matrix tool for assessing, for example via a questionnaire, the severity of threats associated with a pandemic; or (7) a Business Continuity tool that provides templates or outlines for each unit of an entity to establish continuity.

### III. Practice Stage

Conducting the Practice stage 120 is the third step in the pandemic planning process according to the present invention. The Practice stage 120 simulates the action plans from the Planning stage 110, for example, by at least one of conducting walkthroughs of the action plans, by discussing the core requirements and action plans in teams, or by evaluating the impacts of the action plans. The Practice stage 120 identifies potential gaps, thereby allowing an entity to tune its pandemic response and keeping the overall pandemic plan from becoming obsolete. The action plans developed in the Planning stage 110 may be modified as needed and validated. Modified and/or validated action plans may be inventoried in at least one database. In embodiments, the Practice stage 120 may provide a closed loop with the Preparation stage 105 for a continuous improvement process loop.

The Practice stage 120 takes into account the People focus area 150 by simulating the communication plans to ensure correct execution. In embodiments, a crisis management team may walk-through at least one of site, regional, country, or entity-wide educational and communication plans. The Practice stage 120 tests cross-organization dependencies, including both internal dependencies and external dependencies. Changes to the communication plans may be made and stored in a database, for example, the policies database.

The Practice stage 120 takes into account the Policy focus area 160 by simulating policies relating to at least one of people, assets, infrastructure, services, or processes. The Practice stage 120 tests cross-organization dependencies, including both internal dependencies and external dependencies. Modification of policies may be made and stored in a database, for example, the policies database.

The Practice stage 120 takes into account the Process focus area 170 by testing key processes. For example, testing of the key processes ensures that goods and/or services can be delivered at least one of customers or employees during a pandemic. As a result of the testing, modification to such processes may be made and stored in a database, for example, the pandemic management database.

The Practice stage 120 takes into account the Politics focus area 180 by simulating the governance model and testing decision making processes for effectiveness. Thus, the Practice stage helps to ensure consistent governance of an entity and any of its subunits. As a result of the testing, governance models may be modified and stored in a database.

In embodiments, the simulation of action plans may be facilitated by using at least one of (1) team rooms; (2) databases; (3) a Monitoring tool; or (4) a Conferencing tool; (5) a Business Transformation Management tool; (6) a Threat Assessment Matrix tool; or (7) a Business Continuity tool.

### IV. Performance Stage

Conducting the Performance stage 130 is the final step in the pandemic planning process according to the present invention. The Performance stage 130 includes executing the action plans and tracking performance. The Performance stage 130 ensures readiness by making certain that the systems needed to support the pandemic planning are built and remain current. The Performance stage 130 also tracks and monitors issues throughout the lifecycle of the pandemic. Thus, the Performance stage 130 ensures that an overall pandemic plan is consistent and repeatable.

The Performance stage 130 takes into account the People focus area 150 by executing the action plans developed in the Planning stage 110 and practiced in Practice stage 120, which take into account the People focus area. Gaps and failures are identified, tracked, analyzed, and addressed to avoid future problems.

The Performance stage 130 takes into account the Policy focus area 160 by executing the action plans developed in the Planning stage 110 and practiced in Practice stage 120, which take into account the Policy focus area.

The Performance stage 130 takes into account the Process focus area 170 by executing the action plans developed in the Planning stage 110 and practiced in Practice stage 120, which take into account the Process focus area.

The Performance stage 130 takes into account the Politics focus area 180 by executing the governance models developed in the Planning stage 110 and practiced in Practice stage 120, which take into account the Politics focus area.

In embodiments, the execution of the overall pandemic plan may be facilitated by using at least one of (1) team rooms; (2) databases; (3) a Monitoring tool; or (4) a Conferencing tool; (5) a Business Transformation Management tool; (6) a Threat Assessment Matrix tool; or (7) a Business Continuity tool. The entire pandemic response may be tracked and monitored, both across an entire entity and across at least one subunit. In embodiments, a Scorecard, for example a computer dashboard, may show at least one of individual or aggregate levels of performance. Accordingly, pandemic readiness may be evaluated.

### V. Updating

According to the present invention, an overall pandemic plan, once developed, may be updated periodically, for example, every six months or annually by going through the four stages. Alternatively, the pandemic plan may be updated if evidence exists that a pandemic has spread to a certain geographic area, for example, Europe or North America. The updating ensures that new technologies and changes in entity structure or operation are taken into account, thereby preventing the overall pandemic plan from becoming out-of-date.

### VI. System

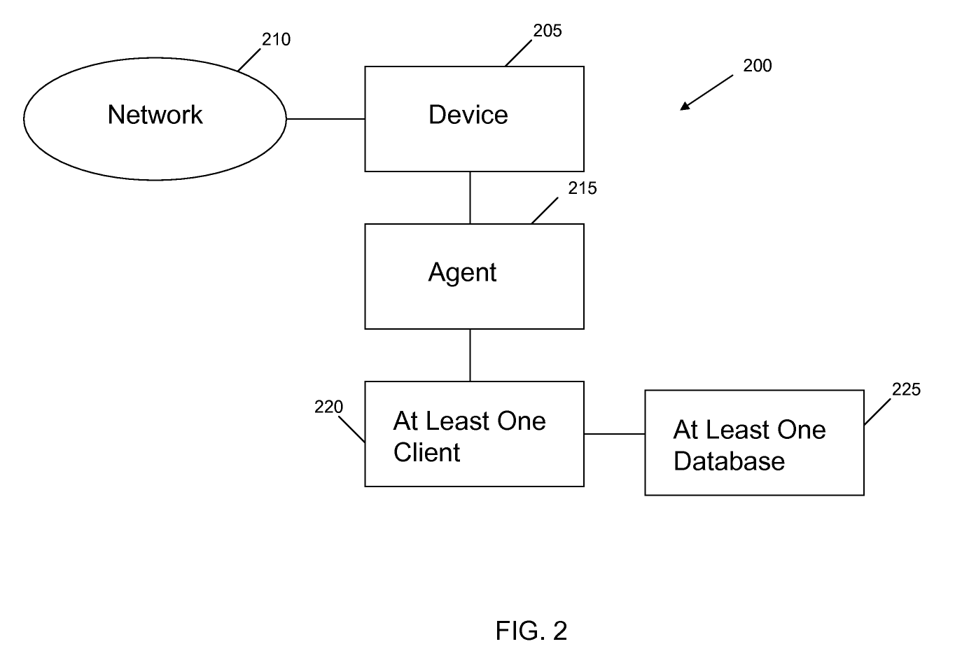

FIG. 2 is a block diagram showing an illustrative system of the invention, 200. The illustrative system includes at least one electronic or digital device 205 (e.g., a personal computer, cellular telephone, personal digital assistant or PDA, game device, MP3 player, television). The at least one device may be connected to a network 210 (e.g., the internet, world wide web, local area network (LAN), wide area network (WAN)). In embodiments, the system includes an agent 215 for allowing a preparation stage, a planning stage, a practice stage, and performance stage of a pandemic planning process; at least one client 220, and at least one database 225 for storing at least one of communications, policies, processes, or governance models. The agent and at least one client may be applications residing on the at least one electronic or digital device. The illustrative system is but one example, and one of ordinary skill in the art would recognize that many other variations may exist, all of which are contemplated by the invention.

The at least one database 225 may store at least one of communications, policies, processes, or governance models. The at least one database may also comprise team rooms, which may comprise a repository of materials including, but not limited to, at least one of meeting minutes, reference materials, status of projects, workflow items, a library of IT documents, spreadsheets, presentations, or any combination thereof.

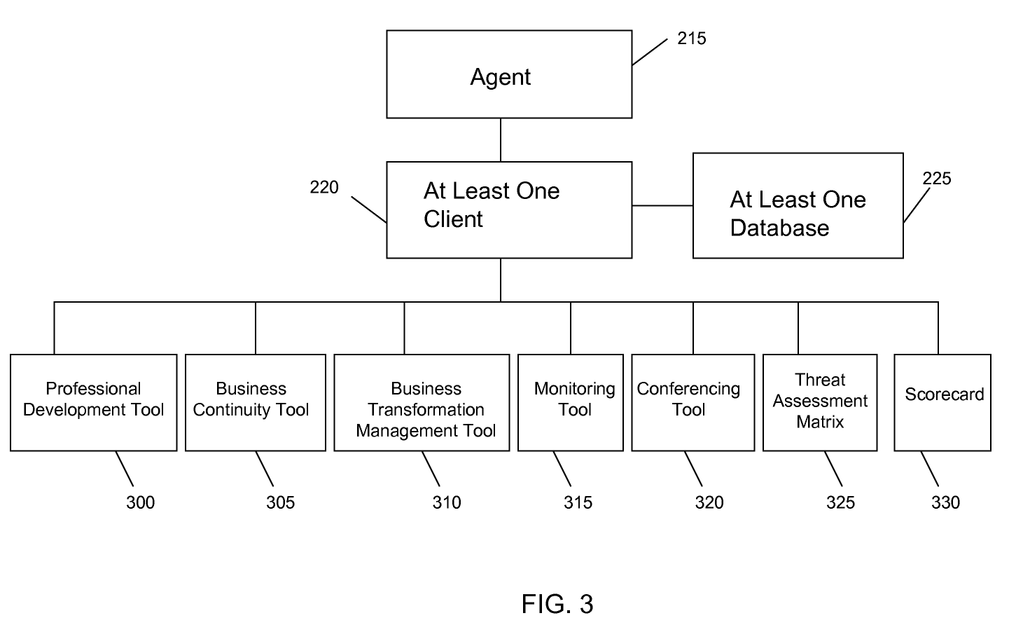

As shown in FIG. 3, the at least one client 220 may comprise at least one of (1) a Professional Development tool 300 that assesses skills of employees or other members of an entity; (2) a Business Continuity tool 305 that provides templates or outlines for each unit of an entity; (3) a Business Transformation Management tool 310 for identifying at least one of key employees, customers, clients, or government regulations and requirements; (4) a Monitoring tool 315 that tracks and monitors usage (uptime and downtime) of at least one of key infrastructure, services, or resources; (5) a Conferencing tool 320, such as phone or videoconferencing; (6) a Threat Assessment Matrix tool 325 for assessing the severity of threats associated with a pandemic; or (7) a Scorecard 330 to show at least one of individual or aggregate levels of performance and pandemic readiness.

Any tool or any combination thereof may be used in each Stage of the pandemic planning process. In embodiments, the Professional Development tool 300 and Business Continuity tool 305 may be used in the Preparation stage 105. In embodiments, the Business Continuity tool 305, Business Transformation Management tool 310, Monitoring tool 315, Conferencing tool 320, and Threat Assessment Matrix tool 325 may be used in at least one of the Planning stage 110, Practice Stage 120, or Performance stage 130. In embodiments, the Scorecard 330 may be used in the Performance stage 130.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of at least one general purpose computer, special purpose computer(s), or other programmable data processing apparatus to produce a machine, such that the instructions, which execute via the processor of the computer or other programmable data processing apparatus, create means for implementing the functions specified in the flowcharts or block diagrams.

The following non-limiting example is directed to a mobility program. In point-in-time catastrophes, infrastructure is predominantly affected. In contrast, a pandemic predominantly affects people and workforces. Accordingly, establishing a mobility program that allows workers to operate from their homes is an important component of effective pandemic planning.

### EXAMPLE

### A. Preparation Stage

The People focus area is taken into account by defining the scope of a pandemic mobility program and defining base rules regarding how to work during a pandemic. In addition, home telecommunications connections are identified and inventoried.

The Policy focus area is taken into account by establishing an employee eligibility policy for mobile technology. Policies regarding rules to reclaim or optimize costs associated with the mobile technology are adopted, such as excluding some units from delivery due low level usage (e.g., printers).

The Process focus area is taken into account by defining when mobility technology deployment takes place (e.g., declaration of pandemic level 4 by WHO). Delivery of mobility technology is defined to operate within a certain amount of time (e.g., 1 week). This stage avoids investments in mobility technology and its deployment prior a certain pandemic level.

The Politics focus area is taken into account by developing a governance model to align mobility technology delivery with the financial affordability as well as with the expected mobile workforce. The governance model defines an endpoint for mobility technology. The governance model also ensures that the pandemic planning is not misused to gain pandemic-independent deployments. A substitution model is developed that achieves fast delivery of network access (e.g., use of wireless technology as much as possible) and use of resilient infrastructures (e.g., use of landline phones instead of cell phones) with financial affordability.

### B. Planning Stage

The People focus area is taken into account by developing action plans to implement communications covering technologies to use and substitute solutions in case of breakage. Action plans for the management of employee availability (e.g., plan, report, manage change) and inventory management for employee buy-in items are implemented.

The Policy focus area is taken into account by developing action plans to implement eligibility and re-claim rules with organizations for mobility technology. The policies ensure fast decision process (e.g., order approvals) as standard processes may be too slow or complex (e.g., several approvals) to ensure fast delivery.

The Process focus area is taken into account by developing actions plans to implement ordering and deploying mobility equipment according eligibility rules. Items which lead to financial re-claim (e.g., printers) will be administrated after the crisis. Action plans to coordinate delivery logistics with delivery organizations and supplying organizations are developed, as well as for setup of equipment support.

The Politics focus area is taken into account by clarifying decision-making for approval and order within all affected organizations and budget-owning units. For example, it is clarified that a defined portion of units (e.g., printers) will be purchased by employees, leading to some financial re-claim.

### C. Practice Stage

The People focus area and Policy focus area are taken into account by walking through the action plans and testing cross-organization dependencies.

The Process focus area is taken into account by walking through deployment related services (e.g., in-house delivery and external suppliers-based delivery).

The Politics focus area is taken into account by simulating services and deployment processes and documenting potential non-compliance with standard processes. Communication with a Crisis Management Team is essential due to geographical dependencies as well as government rules and restrictions.

### D. Performance Stage

The People focus area is taken into account by observing and monitoring mobility technology needs based upon employee availability and tracking the availability of the mobile technology. The Policy focus area is taken into account by approving rules to order mobility equipment. The Process focus area is taken into account by ordering mobility equipment and tracking performance of external and internal suppliers.

The Politics focus area is taken into account by communicating progress of delivery of the mobility equipment to a Crisis Management Team with a specific focus on employee-related deployment, resilience of service, expectations from internal suppliers, and expectations from external suppliers.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

What is claimed is:

1. A method for pandemic planning, comprising:
conducting a preparation stage comprising identifying and inventorying core requirements of an entity's operation;
conducting a planning stage comprising developing action plans to implement the identified core requirements; and
conducting a practice stage comprising simulating the action plans;
wherein each stage considers a people focus area, a policy focus area, a process focus area, and a politics focus area.

2. A method according to claim 1,
wherein the people focus area comprises actions to ensure that members of the entity understand their responsibilities in the event of a pandemic,
wherein the policy focus area comprises actions to establish consistent entity policies applying to at least one of people, assets, infrastructure, services, or processes in the event of a pandemic,
wherein the process focus area comprises actions to enable an entity to understand its key processes and supporting infrastructure in the event of a pandemic,
wherein the politics focus area comprises actions to determine the governance of an entity in the event of a pandemic.

3. A method according to claim 1, wherein said core requirements comprise at least one of people, assets, infrastructure, services, or processes.

4. A method according to claim 1, wherein said conducting a preparation stage comprises:
establishing at least one crisis management team;
identifying and inventorying communications that must be provided to members of an entity in the event of a pandemic;
identifying and inventorying policies affecting at least one of people, assets, infrastructure, services, or processes in the event of a pandemic;
identifying and inventorying processes that support and facilitate the management of at least one of people, assets, infrastructure, or services in the event of a pandemic; and
establishing a governance model to standardize decision-making during a pandemic.

5. A method according to claim 1, wherein said conducting a preparation stage comprises identifying and inventorying skills and educational level for members of an entity.

6. A method according to claim 1, wherein said conducting a preparation stage comprises defining when a pandemic occurs.

7. A method according to claim 4, wherein the communications that must be provided to members are directed to at least one area of security, safety, work requirements, benefits, or payroll.

8. A method according to claim 4, wherein a list of key processes are identified and inventoried for each unit of an entity.

9. A method according to claim 1, wherein said conducting a planning stage comprises:
developing action plans to implement communications across an entity on at least one of a site, regional, country, or entity-wide level;
developing action plans to ensure consistent implementation of policies;
developing action plans to implement and support key processes; and
developing action plans to implement a governance model.

10. A method according to claim 9, wherein said conducting a practice stage comprises simulating the action plans.

11. A method according to claim 10, wherein said simulating of the action plans comprises at least one of conducting walkthroughs of the action plans, discussing the core requirements and action plans in teams, or evaluating the impacts of the action plans.

12. A method according to claim 9, wherein action plans are modified as needed and validated.

13. A method according to claim 1, further comprising conducting a performance stage comprising executing the action plans and tracking performance.

14. A method according to claim 1, further comprising updating an overall pandemic plan periodically.

15. A method according to claim 1, wherein said entity is at least one of a businesses, governments, government agencies, communities, the military, hospitals, universities, or schools.

16. A method for pandemic planning, comprising:
conducting a preparation stage comprising identifying and inventorying core requirements of an entity's operation;
conducting a planning stage comprising developing action plans to implement the identified core requirements;
conducting a practice stage comprising simulating the action plans; and
conducting a performance stage comprises executing the action plans and tracking performance,
wherein each stage considers a people focus area, a policy focus area, a process focus area, and a politics focus area.

17. A system for pandemic planning, comprising:
an agent for allowing a preparation stage, a planning stage, a practice stage, and a performance stage of a pandemic planning process; and
at least one database for storing at least one of communications, policies, processes, or governance models.

18. A system according to claim 17, wherein the database comprises a repository of at least one material comprising meeting minutes, reference materials, status of projects, workflow items, a library of IT documents, spreadsheets, presentations, or any combination thereof.

19. A system according to claim 17, wherein the agent comprises at least one client comprises at least one of:
a Professional Development tool that assesses skills of employees of an entity;
a Business Continuity tool that provides templates for each unit of an entity;
a Business Transformation Management Tool for identifying at least one of key employees, customers, clients, or government regulations and requirements;
a Monitoring tool that tracks and monitors usage of at least one of key infrastructure, services, or resources;
a Conferencing tool;
a Threat Assessment Matrix tool for assessing the severity of threats associated with a pandemic; or
a Scorecard to show at least one of individual or aggregate levels of performance.

20. A computer program product, comprising:
a computer useable medium having a computer readable program, wherein the computer readable program when executed on a computer causes the computer to:
conduct a preparation stage comprising identifying and inventorying core requirements of an entity's operation;
conduct a planning stage comprising developing action plans to implement the identified core requirements;
conduct a practice stage comprising simulating the action plans; and
conduct a performance stage comprising executing the action plans and tracking performance,
wherein each stage considers a people focus area, a policy focus area, a process focus area, and a politics focus area.
